(19) United States
(12) Patent Application Publication
(10) Pub. No.: US 2008/0080535 A1
(43) Pub. Date: Apr. 3, 2008

(54) METHOD AND SYSTEM FOR TRANSMITTING PACKET

(75) Inventors: Hongyu LI, Shenzhen (CN); Ruobin ZHENG, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/862,839

(22) Filed: Sep. 27, 2007

(30) Foreign Application Priority Data
Sep. 29, 2006 (CN) 200610152453.1

(51) Int. Cl. H04L 12/28

(52) U.S. Cl. 370/401

(57) ABSTRACT

A method for transmitting a packet, includes: receiving, by a first virtual MAC gateway, a packet from a first virtual MAC sub-network, sending, by the first virtual MAC gateway, the packet to a second virtual MAC sub-network according to a destination address of the packet and a virtual MAC address forwarding table; wherein the first virtual MAC sub-network and the second virtual MAC sub-network correspond to different virtual MAC address domains. A device and system for transmitting a packet is also disclosed. By the solution, inter-working between different virtual MAC address domains is enabled.

This application claims priority to Chinese Patent Application No. 200610152453.1, filed Sep. 29, 2006, which is hereby incorporated by reference.

### FIELD OF THE INVENTION

The present invention relates to computer and communication network technologies, and more particularly, to a method and system for transmitting a packet.

### BACKGROUND OF THE INVENTION

The architecture of a Provider Backbone Bridges Network (PBN) specified by Institute of Electrical and Electronic Engineers (IEEE) Standard 802.1ah is shown in FIG. 1. In the PBN, a packet of a Provider Bridge (PB) can be completely encapsulated in a packet of a Provider Backbone Bridge (PBB). Therefore, the PBN provides a hierarchy network, and a foundation for the connection of Ethernet or the tunnel technology. The encapsulation format of an 802.1ah packet is shown in Table 1.

TABLE 1

| | | | | | | | |
|---|---|---|---|---|---|---|---|
| B-DA | B-SA | B-Tag | I-Tag | S-Tag | C-DA | C-SA | C-Data |

As shown in table 1, the 802.1ah packet consists of Provider Backbone Bridge Destination Medium Access Control (MAC) Address (B-DA), Provider Backbone Bridge Source MAC Address (B-SA), Provider Backbone Bridge Tag (B-Tag), Service Instance Tag (I-Tag), Service Tag (S-Tag), Customer Destination MAC Address (C-DA), Customer Source MAC Address (C-SA) and Customer Data (C-Data).

As shown in Table 1, the customer packet transported from the PB to the PBB including C-DA, C-SA and C-Data is completely encapsulated in the PBB packet. The Provider Backbone Bridge MAC Address (B-MAC) including B-DA and B-SA is the MAC address of the PBB device. The B-Tag is defined according to Standard IEEE 802.1q. In a PBB network, a packet may only be forwarded via the Ethernet forwarding mode of Standard IEEE 802.1q according to B-MAC and B-Tag.

As shown in Table 1, in the hierarchy network of PBN, the MAC address of the customer (i.e. C-DA or C-SA) is isolated from the MAC address of the provider network device (i.e. B-DA or B-SA). The tag of the customer (i.e. I-TAG) is isolated from the tag of the provider (i.e. S-TAG).

The Provider Backbone Transport (PBT) may be implemented on the basis of the PBN. The PBT technology has the following characteristics.

1. The device implementing the PBT supports the Individual Virtual Local Area Network (VLAN) Learning (IVL).

2. Because the device implementing the PBT supports the IVL, the VLAN may be categorized into a connection-oriented VLAN (i.e. PBT VLAN) and a connectionless VLAN (i.e. common VLAN). In other words, a portion of VLAN may be designated as the PBT VLAN in the device associated with the PBT and may be used separately from other common VLANs without impact on each other.

3. MAC address learning and spanning tree protocol are disabled in the PBT VLAN.

4. Broadcast and multicast functions of unknown packets are disabled in the PBT VLAN.

The PBT transport network is shown in FIG. 2. The Provisioning and management system connects with all Provider Edge Bridges (PEBs) and PBs. The provisioning and management system is used for configuration and link maintenance, such as state detection and path protection and other control and management functions.

As shown in FIG. 2, the PBT transport network includes a plurality of PEBs and a plurality of PBs. The PEBs and the PBs are generally Ethernet switches supporting the IVL. In the Ethernet switches, the destination MAC address and the PBT Virtual LAN Identifier (VID) are configured respectively. The destination MAC address and the PBT VID form a tag which is an identifier of a channel. An Ethernet Switched Path (ESP) is formed by transporting the identifier of the channel over the plurality of the Ethernet switches supporting the IVL. The channel may be a connection, i.e. Ethernet Virtual Connection (EVC) or tunnel. The MAC address, VID and forwarding mode used by the PBT technology are complied with Standard IEEE 802.1q.

The method for forwarding data through the ESP is as follows.

The provisioning and management system configures links, for example, configures the links of the PBT dynamically or statically via the control plane of General Multi-Protocol Label Switching (GMPLS), and maintains the state of the links.

Subsequently, the provisioning and management system learns the MAC address by using the IVL on the network nodes, such as the PEB and PB in FIG. 2, on the transport path ESP of the PBT, and configures the forwarding table of MAC addresses of the PBT.

A PEB forwards customer traffic to a next-hop node according to the forwarding table; the next-hop node forwards the customer traffic to another next-hop node according to the forwarding table. At last, the customer traffic is forwarded to another PEB connecting with a destination customer network. The intermediate network nodes, i.e. the PBs, forward packets without any other processing. For example, in FIG. 2, the provisioning and management system configures an ESP from PEB1 to PEB3 statically. A forwarding table is configured on PEB1, intermediate PBs and PEB3. The MAC address of PEB3 and VLAN 44 are taken as the tag of the ESP. The MAC address of PEB1 contained in packets would indicate the source device of the ESP. The ESP is a unidirectional path.

The PBT devices use globally unique MAC addresses, which can not be planned uniformly by the network manager and cannot be converged. The number of different ESPs arriving at the same device is limited to be no larger than 4096 by the number of PBT VID. Using the destination MAC address and VID to identify the ESP can not support Point-to-Multipoint (P2MP) connections, Multipoint-to-Multipoint (MP2MP) connections, multicast connections or broadcast connections.

For the purpose of solving the above problems, a management domain is set in the PBN; virtual MAC addresses are uniformly configured in node devices of the management domain according to a predetermined converging principle, and the identity information for identifying home virtual MAC address domain of each of the node devices is introduced into the management domain. When customer traffic is forwarded in the PBN with the management domain set, a node device on the edge of the management domain encapsulates the customer traffic using the virtual MAC addresses, and forwards the customer traffic to a destination node device through a forwarding path configured by the virtual MAC addresses.

In the management domain shown in FIG. 3, nodes a, b, c, d, e and f are edge nodes for encapsulating customer traffic. Nodes x and y are convergence nodes for converging and forwarding the customer traffic in PBT encapsulation. The virtual MAC addresses of the nodes in FIG. 3 may be designated according to Table 2. The mask of MAC address is represented by anti-mask mode. In other words, the mask is represented by reverse mask, i.e. to count the low bit being 0 in a mask. For example “/16” in Table 2 represents mask FFFF-FFFF-0000. The network may be divided into different convergence layers according to the different digits of mask to perform multi-level convergence. In this case, each convergence node practically corresponds to one virtual MAC address domain.

TABLE 2

| | Virtual MAC |
|---|---|
| Edge node | Address |
| a | 00E0-1000-1000/16 |
| b | 00E0-1000-2000/16 |
| c | 00E0-1000-3000/16 |
| d | 00E0-2000-1000/16 |
| e | 00E0-2000-2000/16 |
| f | 00E0-2000-3000/16 |
| x | 00E0-1000-0000/32 |
| y | 00E0-2000-0000/32 |

ESP 1 from node a to node d may be represented by DA: 00E0-2000-1000/16 or DA: 00E0-2000-1000/16+VID 100. ESP 2 from node b to node e may be represented by DA: 00E0-2000-2000/16 or DA: 00E0-2000-2000/16+VID 100. The component of the forwarding table on node x may be represented by the Table 3 or by Table 4 which is converged.

TABLE 3

| | | Egress port |
|---|---|---|
| Destination | | (to describe conveniently, |
| virtual | | which is represented by the node |
| MAC Address | VID | connected to the egress port) |
| 00E0-2000-2001/0 | 100 | y |
| 00E0-2000-2002/0 | 100 | y |

TABLE 4

| | | Egress port (to describe |
|---|---|---|
| | | conveniently, which is |
| Destination virtual | | represented by the node |
| MAC Address | VID | connected to the egress port) |
| 00E0-2000-XXXX/16 | 100 | y |

Broadcast or point-to-multipoint connections can be implemented by using the broadcast address of virtual MAC address domain. For example, in the network shown in FIG. 3, if node c is the entry of an ESP, and the ESP is identified by taking 00E0-2000-FFFF/16 as the destination MAC, node y will forward traffic sent by node c to nodes d, e and f at the same time.

The technology of management domain employs the virtual and hierarchical MAC address, the mask of MAC address and the MAC address domain, so that the problem that the MAC address cannot be planned or converged within the PBT technology is solved. However, inter-working between different virtual MAC address domains is not possible yet.

### SUMMARY OF THE INVENTION

An embodiment of the present invention provides a method and a system for transmitting a packet, so that inter-working between different virtual MAC address domains is enabled.

A method for transmitting a packet includes: receiving, by a first virtual MAC gateway, a packet from a first virtual MAC sub-network, and sending, by the first virtual MAC gateway, the packet to a second virtual MAC sub-network according to a destination address of the packet and a virtual MAC address forwarding table; wherein the first virtual MAC sub-network and the second virtual MAC sub-network corresponds to different virtual MAC address domains.

A device for transmitting a packet includes a forwarding control unit, an interface unit and a forwarding table configuration unit; and the forwarding control unit is configured to receive, via the interface unit, a packet from a first virtual MAC sub-network, and send the packet, via the interface unit, to a second virtual MAC sub-network according to a destination address of the packet and a virtual MAC address forwarding table in the forwarding table configuration unit; the interface unit is configured to receive the packet from the first virtual MAC sub-network, and send the packet to the forwarding control unit; receive the packet from the forwarding control unit, and send the packet to the second virtual MAC sub-network; the forwarding table configuration unit is configured to save the virtual MAC address forwarding table; and the first virtual MAC sub-network and the second virtual MAC sub-network corresponds to different virtual MAC address domains.

A system for transmitting a packet includes: a plurality of virtual MAC sub-networks and at least one virtual MAC gateway; the plurality of virtual MAC sub-networks corresponds to different virtual MAC address domains; each of the plurality of virtual MAC sub-networks includes one or more nodes with virtual MAC addresses; each node forwards a packet to a next-hop node or the virtual MAC gateway according to a destination address of the packet and a virtual MAC address forwarding table; and the virtual MAC gateway is configured to forward the packet among the plurality of the virtual MAC sub-networks according to the destination address of the packet and the forwarding table.

As can be seen from the above technical scheme, a packet can be transmitted between different virtual MAC sub-networks by use of a virtual MAC gateway, so that the inter-working between different virtual MAC address domains is enabled.

### BRIEF DESCRIPTION OF THE DRAWINGS

FIG. 1 is a simplified schematic diagram illustrating the structure of a conventional PBN network.

FIG. 2 is a simplified schematic diagram of the PBT transport network.

FIG. 3 is a simplified schematic diagram illustrating a conventional hierarchical virtual MAC address domain.

FIG. 4 is a simplified schematic diagram of virtual MAC space in accordance with an embodiment of the present invention.

FIG. 5 is a simplified schematic diagram of a virtual MAC sub-network in accordance with an embodiment of the present invention.

FIG. 6 is a simplified schematic diagram of transporting packets between two virtual MAC sub-networks in accordance with an embodiment of the present invention.

FIG. 7 is a simplified flowchart of forwarding a packet in accordance with an embodiment of the present invention.

FIG. 8 is a simplified schematic diagram illustrating the virtual MAC sub-network for multiple nodes connecting with one virtual MAC gateway in accordance with an embodiment of the present invention.

FIG. 9 is a simplified schematic diagram illustrating a first enhanced topology of three virtual MAC sub-networks.

FIG. 10 is a simplified schematic diagram illustrating a second enhanced topology of three virtual MAC sub-networks.

FIGS. 11 and 12 are simplified schematic diagrams illustrating a third enhanced topology of three virtual MAC sub-networks.

FIG. 13 is a simplified schematic diagram illustrating an virtual MAC gateway in accordance with an embodiment of the present invention.

FIG. 14 is a simplified schematic diagram illustrating the structure of the system in accordance with an embodiment of the present invention.

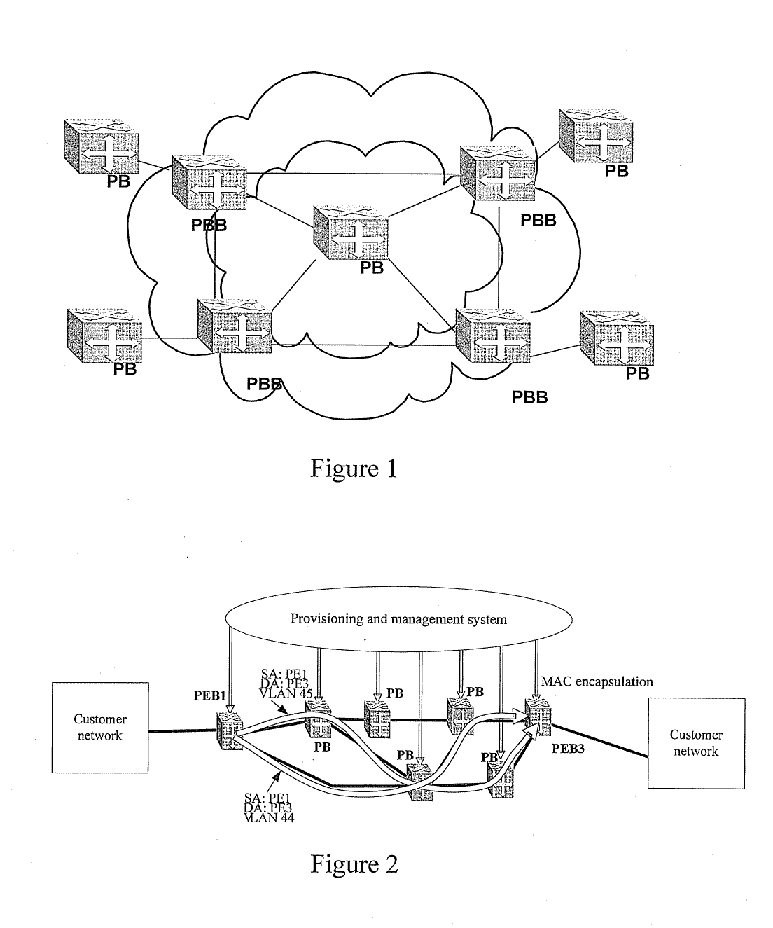

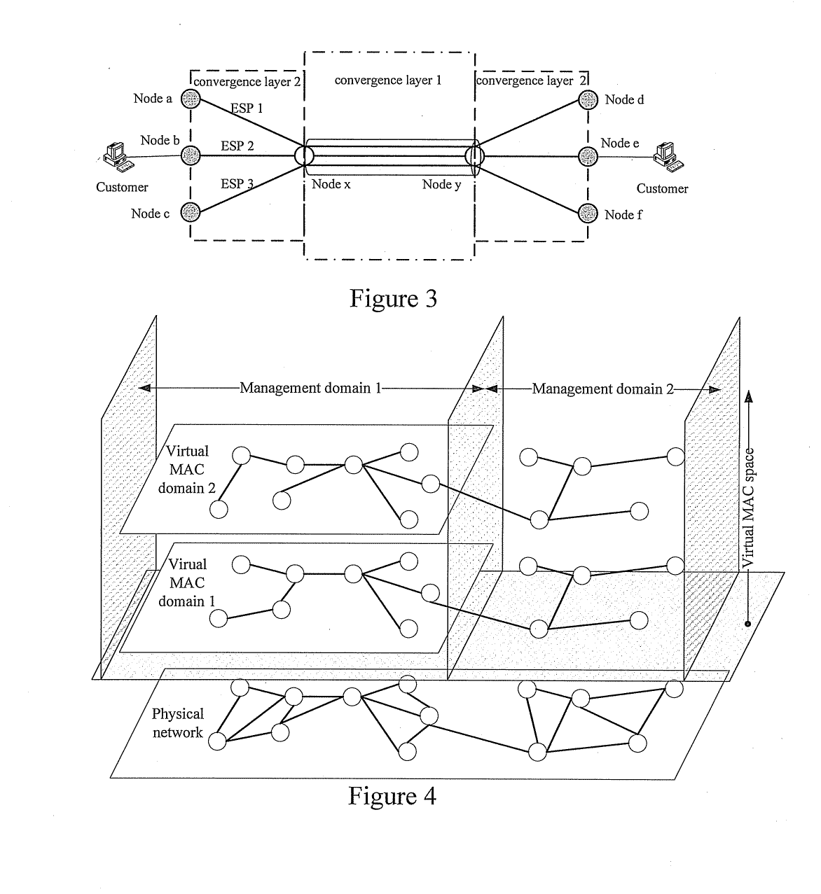

### DETAILED DESCRIPTION OF THE INVENTION

The present invention is described as follows in detail with reference to the accompanying drawings to make the technical schemes and advantages of the present invention more apparent.

The concept of virtual MAC space is introduced into the existing virtual MAC address in accordance with the present invention. FIG. 4 is a schematic diagram of the virtual MAC space. The virtual MAC space is a portion of the network using virtual MAC addresses. In other words, virtual MAC addresses are configured in some nodes of the network and are used for forwarding data. Virtual MAC space may include one or multiple management domains. Each management domain can implement virtual MAC addresses assignment independently. One management domain may support multiple different virtual MAC address domains simultaneously. Multiple management domains may coordinate in assignment of the virtual MAC addresses for a better whole assignment. A physical node associated with the virtual MAC space may support a virtual MAC address and the original physical MAC address of the virtual MAC address simultaneously and support the forwarding of virtual MAC address and the forwarding of non-virtual MAC address (i.e. physical MAC address) simultaneously. However, the virtual MAC space only includes the portion of such physical nodes associated with virtual MAC addresses. With reference to FIG. 4, the virtual MAC space is divided into two management domains. The first Management domain configures two different virtual MAC address domains. The second Management domain configures one virtual MAC address domain.

The concepts of virtual MAC sub-network and virtual MAC gateway are further described as follows under the framework of virtual MAC space.

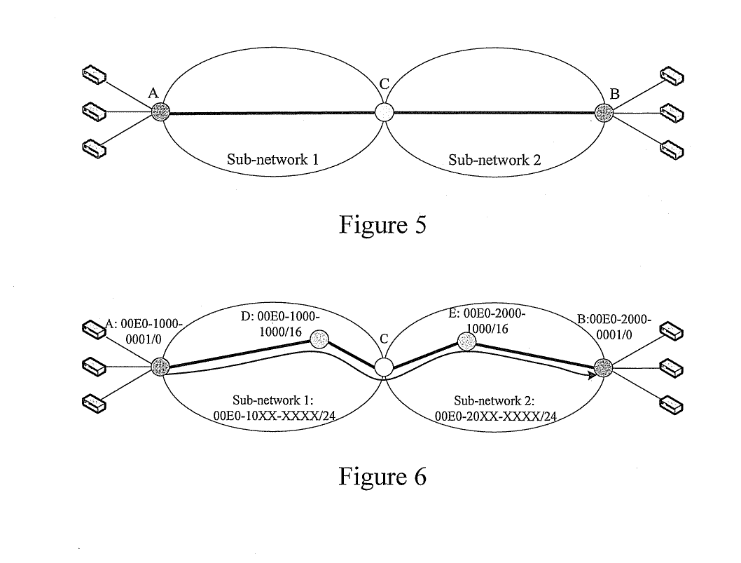

With reference to FIG. 5, Sub-networks 1 and 2 are two virtual MAC sub-networks. Node A is a convergence node or a non-convergence node of virtual MAC sub-network 1. Node B is a convergence node or a non-convergence node of virtual MAC sub-network 2. Node C is a virtual MAC gateway of virtual MAC sub-networks 1 and 2.

A virtual MAC sub-network has the following characteristics.

1. A virtual MAC sub-network is located in a virtual MAC space.

2. All virtual MAC addresses of a virtual MAC sub-network belong to one virtual MAC address domain. The virtual MAC address domain is indicated by a virtual MAC address on a gateway node of the virtual MAC sub-network representing the virtual MAC sub-network. The virtual MAC address domain is represented by the mask mode. In embodiments of the present invention, the reverse mask is adopted while in practice, the subnet mask may be adopted. For example, 00E0-10XX-XXXX/24 is a virtual MAC address domain while 00E0-1011-1234/24 is a virtual MAC address of the virtual MAC address domain.

3. Nodes of virtual MAC sub-network may be divided into different hierarchical virtual MAC addresses (domains) according to the different mask lengths of virtual MAC address.

4. One or multiple gateway nodes may be included in a virtual MAC sub-network.

5. Different virtual MAC address domains of a management domain may be respectively taken as different virtual MAC sub-networks.

A non-convergence node, which is termed as an edge node, is connected with network devices outside of the virtual MAC sub-network. The non-convergence node is used to forward packets between nodes of the virtual MAC sub-network and devices outside of the virtual MAC sub-network. For example, the non-convergence node receives a packet from a device outside of the virtual MAC sub-network, encapsulates a destination virtual MAC address into the packet, and forwards the packet to another node of the virtual MAC sub-network according to a forwarding table entry configured on the non-convergence node. For another example, the non-convergence node receives a packet from a node of the virtual MAC sub-network, de-encapsulates the packet to remove the virtual MAC address(es), and sends the de-encapsulated packet to a device outside of the virtual MAC sub-network. A convergence node forwards data straightforwardly. When a convergence node is located on the edge of the virtual MAC sub-network, the virtual MAC address of the network should be planned with concern, so that the convergence between different management domains may be performed directly over the convergence node. There are two types of encapsulation, one is to encapsulate the original packet with the virtual MAC encapsulation including source and destination MAC addresses, and possibly VID; the other is to replace the source and destination MAC address of the original packet. De-encapsulation is an inverse process of encapsulation.

A virtual MAC gateway may be regarded as an enhanced convergence node shared by two or multiple virtual MAC sub-networks. The virtual MAC gateway is used to forward data between virtual MAC sub-networks. If the virtual MAC gateway is located in the virtual MAC sub-networks, virtual MAC addresses are configured on the virtual MAC gateway respectively for the virtual MAC sub-networks. The virtual MAC addresses are used for indicating the virtual MAC address domains corresponding to the virtual MAC sub-networks. The virtual MAC gateway may be also separated from the virtual MAC sub-networks and connected with the sub-networks via an edge node of each of the sub-networks. The virtual MAC gateway may be located in one or more virtual MAC sub-networks and connected with other virtual MAC sub-networks via other virtual MAC gateways located in the other virtual MAC sub-networks. After receiving a packet, the virtual MAC gateway looks up its virtual MAC address domain in the forwarding table with the destination virtual MAC address in the packet, and forwards the packet to the virtual MAC sub-network corresponding to the virtual MAC address domain. If the virtual MAC address domain corresponding to the destination MAC virtual address in the packet is not found in the forwarding table, the packet is discarded.

An ESP may be identified by the destination virtual MAC address or by the destination virtual MAC address and VID together. The non-convergence node, the convergence node or the virtual MAC gateway may forward a packet on the basis of the destination virtual MAC address or on the basis of the destination virtual MAC address and VID. In the following embodiment, the forwarding is illustrated on the basis of the virtual MAC address.

With reference to FIG. 6, in an embodiment of the present invention, there are two virtual MAC sub-networks. The virtual MAC address of MAC sub-network 1 is 00E0-10XX-XXXX/24. The virtual MAC address of virtual MAC sub-network 2 is 00E0-20XX-XXXX/24. Node A and node B are edge nodes. Node D and node E are convergence nodes. Node C is a virtual MAC gateway located between Virtual MAC sub-network 1 and Virtual MAC sub-network 2 simultaneously. The virtual MAC addresses of virtual MAC sub-network 1 and virtual MAC sub-network 2 are respectively configured on Node C facing respectively each sub-network. A virtual MAC address forwarding table as shown in Table 5 is configured on the virtual MAC gateway node C.

TABLE 5

| | Egress port |
|---|---|
| | (represented by the node |
| Virtual MAC Address | connected to the egress port) |
| 00E0-10XX-XXXX/24 | D |
| 00E0-20XX-XXXX/24 | E |

For an ESP from node A to node B, a forwarding table entry is configured on each edge node and convergence node respectively with reference to Table 6.

TABLE 6

| | | Egress port |
|---|---|---|
| | Virtual MAC | (represented by the node |
| Node | Address | connected to the egress port) |
| A | 00E0-20XX-XXXX/24 | D |
| D | 00E0-20XX-XXXX/24 | C |
| E | 00E0-2000-0001/0 | B |

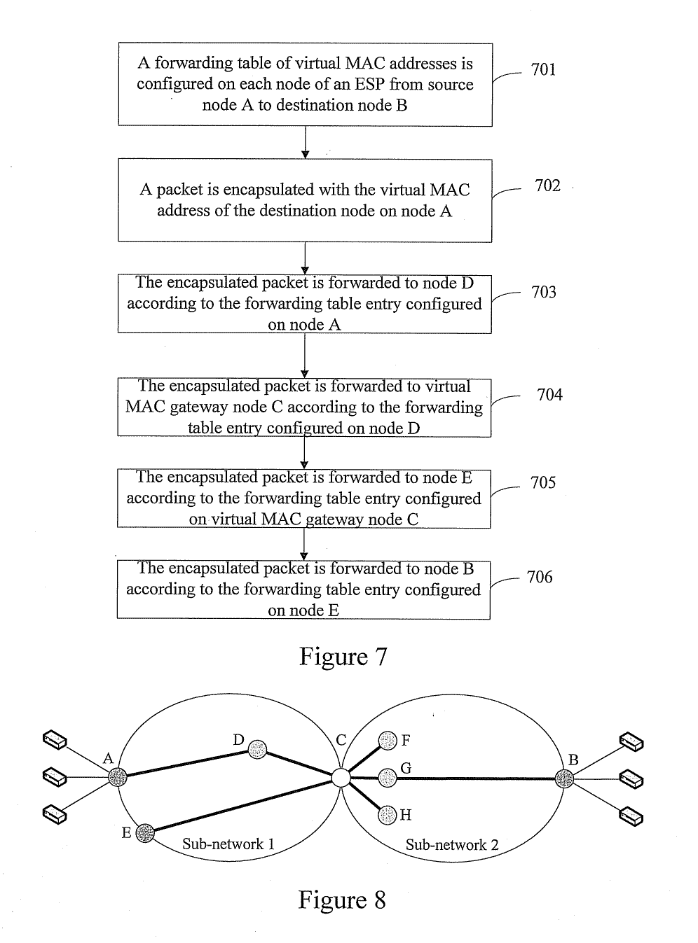

The virtual MAC address entry of a node is the virtual MAC address of a next-hop node. The procedure for forwarding packets through the ESP shown in FIG. 6 is shown in FIG. 7.

Block 701: A forwarding table of virtual MAC addresses is configured on each node of an ESP from source node A to destination node B. The nodes of the ESP from source node A to destination node B include source node A, convergence node D of virtual MAC sub-network 1, virtual MAC gateway node C of virtual MAC sub-network 1 and virtual MAC sub-network 2 and convergence node E of virtual MAC sub-network 2. The forwarding table of node C is shown in Table 5 while the forwarding tables of the other nodes are shown in Table 6.

For example, the virtual MAC address forwarding table may be sent by the provisioning and management system to each node. For another example, every node sends its virtual MAC address to its adjacent nodes, and generates a virtual MAC address forwarding table according to the virtual MAC address received from the adjacent nodes.

Block 702: A packet is encapsulated and added with the virtual MAC address of the destination node on node A. In this embodiment, the destination node is node B.

Block 703: The encapsulated packet is forwarded to node D according to the forwarding table entry configured on node A. In this embodiment, node A is an edge node of virtual MAC sub-network 1 and node B is an edge node of virtual MAC sub-network 2. In other words, node A and node B belong to different virtual MAC sub-networks. Therefore, the encapsulated packet is forwarded to convergence node D of Virtual MAC sub-network 1 according to the forwarding table entry with reference to Table 6.

Block 704: The encapsulated packet is forwarded to virtual MAC gateway node C according to the forwarding table entry configured on node D. In block 704, the encapsulated packet is forwarded from the convergence node to the gateway node.

Block 705: The encapsulated packet is forwarded to node E according to the forwarding table entry configured on virtual MAC gateway node C. In this embodiment, virtual gateway node C determines that the destination node belongs to virtual MAC sub-network 2 according to the destination node address of the packet; then virtual gateway node C forwards the encapsulated packet to convergence node E of virtual MAC sub-network 2 according to forwarding table entry with reference to Table 5.

Block 706: The encapsulated packet is forwarded to node B according to the forwarding table entry configured on node E.

According to the procedure above, when a packet is sent from an edge node of a first virtual MAC sub-network to an edge node of a second virtual MAC sub-network, the packet is forwarded by the edge node of the first virtual MAC sub-network, a convergence node of the first virtual MAC sub-network, a virtual MAC gateway connected with the first virtual MAC sub-network and the second virtual MAC sub-network, a convergence node of the second virtual. MAC sub-network and at last forwarded to the edge node of the second virtual MAC sub-network.

In another embodiment of the present invention, a virtual MAC gateway located in two or more virtual MAC sub-networks may be connected with multiple nodes in at least one of the virtual MAC sub-networks. With reference to FIG. 8, nodes A, B and E are non-convergence nodes. Nodes D, F, G and H are convergence nodes. Node C is a gateway connected with two virtual MAC sub-networks. Virtual MAC gateway node C is connected with multiple nodes in each virtual MAC sub-network. When a packet is sent from virtual MAC sub-network 1 to the virtual MAC gateway, the method for configuring forwarding table entry of nodes in a virtual MAC sub-network is similar to that described in the above embodiment. There are two schemes for forwarding data from the virtual MAC gateway to virtual MAC sub-network 2.

First scheme: The virtual MAC gateway forwards the packet to all nodes connecting to the virtual MAC gateway directly in the virtual MAC sub-network 2. In this case, only one forwarding table entry needs to be configured on the virtual MAC gateway node for each virtual MAC sub-network. The forwarding table entry of the virtual MAC gateway and looking up of the forwarding table can be simplified. Correspondingly, each node in the virtual MAC sub-network receiving the packet verifies the packet respectively. If the destination virtual MAC address of the packet does not belong to its virtual MAC address domain, or the corresponding sub-node or brotherly node can not be found in the forwarding table, the node discards the packet. Otherwise, the node forwards the packet according to the forwarding table. The sub-node is a node in the virtual MAC address domain of the node; correspondingly, the node is the parent node of the sub-node. The brotherly node is a node with the same parent node and mask as the node.

Second scheme: The virtual MAC gateway node looks up a next-hop node for forwarding the packet to the destination node according to the forwarding table, and sends the packet to the next-hop node. The next-hop node is one of nodes connected with the virtual MAC gateway node directly. There may be multiple next-hop nodes for forwarding the packet to the destination node according to the data and the configuration of the forwarding table. In this scheme, the gateway node should configure the forwarding table entry of the virtual MAC address (domain) corresponding to each node connecting with the gateway node; such virtual MAC addresses (domains) corresponding to these forwarding table entries are included in the virtual MAC address domain of virtual MAC sub-network and are not overlapped with each other. When the virtual MAC gateway node sends packet to the destination virtual MAC sub-network, the virtual MAC gateway node needs to find the next-hop node according to the forwarding table entry configured, and forwards packets to the next-hop node. If the destination MAC address of the packet matches multiple table entries (for example the broadcast virtual MAC address in the prior art), the gateway forwards the packet to all the nodes included in all the matched table entries.

For example, the virtual MAC address of Virtual MAC sub-network 1 shown in FIG. 8 is 00E0-10XX-XXXX/24. The virtual MAC address of Virtual MAC sub-network 2 is 00E0-20XX-XXXX/24. Nodes A, E and B are non-convergence nodes. Node D, F, G and H are convergence nodes. The virtual MAC address configured for each node is shown in Table 7.

TABLE 7

| Node | Virtual MAC Address |
|---|---|
| A | 00E0-1010-0001/0 |
| B | 00E0-2000-2001/0 |
| D | 00E0-1010-1000/16 |
| E | 00E0-1000-2001/16 |
| F | 00E0-2000-1000/16 |
| G | 00E0-2000-2000/16 |
| H | 00E0-2000-3000/16 |

If the first scheme is adopted, the forwarding table entry configured to the virtual MAC gateway node C is shown in Table 8.

TABLE 8

| | Egress port |
|---|---|
| Virtual MAC | (represented by the node |
| Address | connected to the egress port) |
| 00E0-10XX-XXXX/24 | D, E |
| 00E0-20XX-XXXX/24 | F, G, H |

When a packet is sent from source node A to destination node B through the ESP, the forwarding process from node A to the virtual MAC gateway node C is similar to that of the embodiment above. When a packet is forwarded to a next-hop node via the virtual MAC gateway node C, the node C can find from a forwarding table as shown in Table 8 that the forwarding table entry corresponding to node B includes egress ports F, G and H. Then node C forwards the packet to nodes F, G and H. Upon receiving the packet, nodes F, G and H respectively verify whether the destination virtual MAC address of the packet belongs to their virtual MAC address domain. For example, the destination virtual MAC address of the packet does not belong to the virtual MAC address domain of node F or node H, node F and H will discard the packet. The destination virtual MAC address of the packet belong to the virtual MAC address domain of node G, therefore, node G forwards the packet to destination node B.

If the second scheme is adopted, the forwarding table configured on the virtual MAC gateway node C entry is shown in Table 9.

TABLE 9

| | Egress port (represented |
|---|---|
| | by the node connected |
| Virtual MAC Address | to the egress port) |
| 00E0-1010-XXXX/24 | D |
| 00E0-1000-XXXX/24 | E |
| 00E0-2000-1XXX/12 | F |
| 00E0-2000-2XXX/12 | G |
| 00E0-2000-3XXX/12 | H |

When a packet is sent from source node A to destination node B through the ESP, the forwarding procedure from node A to the virtual MAC gateway node C is similar to that of Embodiment 1. When the packet is forwarded to a next-hop node via the virtual MAC gateway node C, node C can find from Table 9 that the virtual MAC address domain of the virtual MAC address of destination node B is 00E0-2000-2XXX/12 and the corresponding egress port is G. Therefore, the gateway node C forwards the packet to node G, and then node G forwards the packet to the destination node B.

When the destination MAC address of the packet is a broadcast virtual MAC address, for example, 00E0-2000-FFFF/24, Gateway node C will find three entries corresponding to the broadcast virtual MAC address from Table 9. So the packet will be forwarded to nodes F, G and H. Nodes F, G and H will respectively forward the packet to every node of theirs virtual MAC address domain.

In accordance with the division of virtual MAC address domain or other reasons, there are the following extended types of the relationship between the above virtual MAC sub-networks. The virtual MAC sub-network enhanced topology, the corresponding virtual MAC gateway configuration and the packet forwarding condition are described as follows by taking three virtual MAC sub-networks for example, which may be extended to the condition of more than three virtual MAC sub-networks in practical applications.

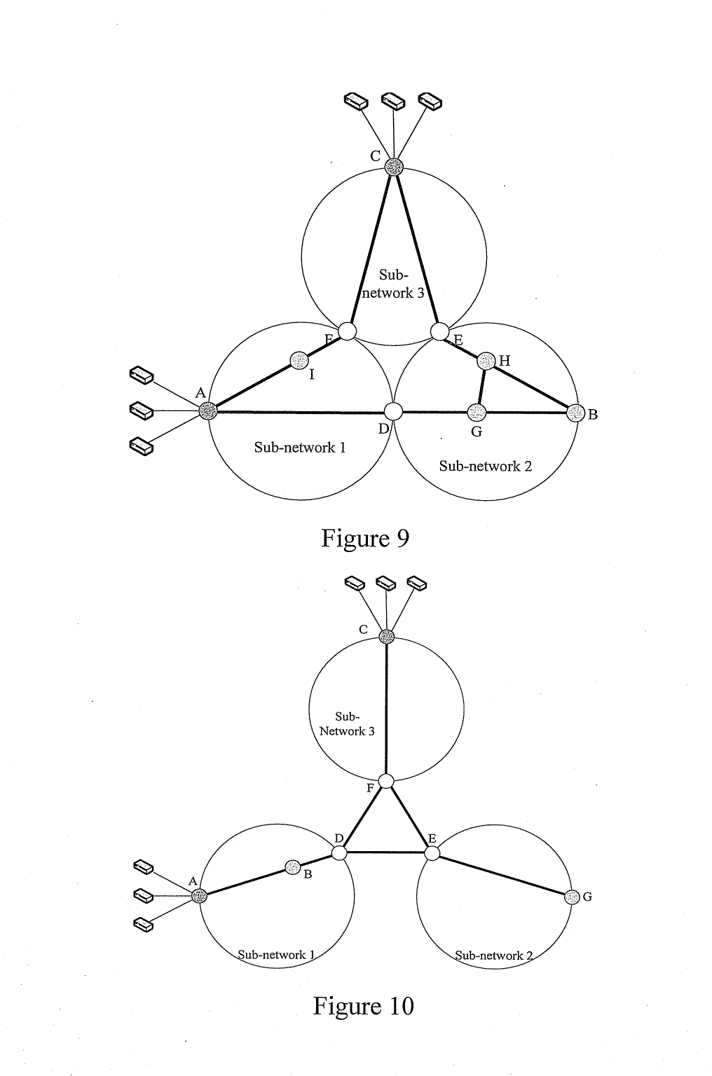

The first enhanced topology of three virtual MAC sub-networks is shown in FIG. 9. Gateway nodes D, E and F are respectively located in two of the three virtual MAC sub-networks. Each gateway node is configured with the virtual MAC address domains related to the two virtual MAC sub-networks sharing the gateway node. Nodes A and C are non-convergence nodes. Nodes B, G, H and I are convergence nodes. The forwarding table between the virtual MAC address domains of the virtual MAC sub-network node may be configured statically or dynamically by the management plane. The shortest path may be generally selected for the ESP from a node in a virtual MAC sub-network to a node of another virtual MAC sub-network. If the shortest path fails, congests or there are other problems, a backup path may also be selected. For example, the shortest ESP from node A of virtual MAC sub-network 1 to node C of virtual MAC sub-network 3 is A-F-C. When a failure occurs on the ESP of A-F-C, packets may be firstly forwarded to Virtual MAC sub-network 2, and then forwarded to virtual MAC sub-network 3. In other words, different gateway nodes are used. In this case, the ESP is A-D-G-H-E-C.

The second enhanced topology of three virtual MAC sub-networks is shown in FIG. 10. Virtual MAC gateway nodes D, E and F, each is located in a virtual MAC sub-network and connects to the other two virtual MAC gateway nodes respectively. Each virtual MAC gateway nodes configures the virtual MAC address of a virtual MAC sub-network where the virtual MAC gateway is located. The forwarding table entries of three virtual MAC sub-networks are configured on each gateway node. Nodes A and C are non-convergence nodes. Nodes B and G are convergence nodes. For this topology, if a shortest ESP fails, a standby ESP can be used. For example, the forwarding from virtual MAC sub-network 1 to virtual MAC sub-network 3 may select the ESP of D-F or the ESP of D-E-F.

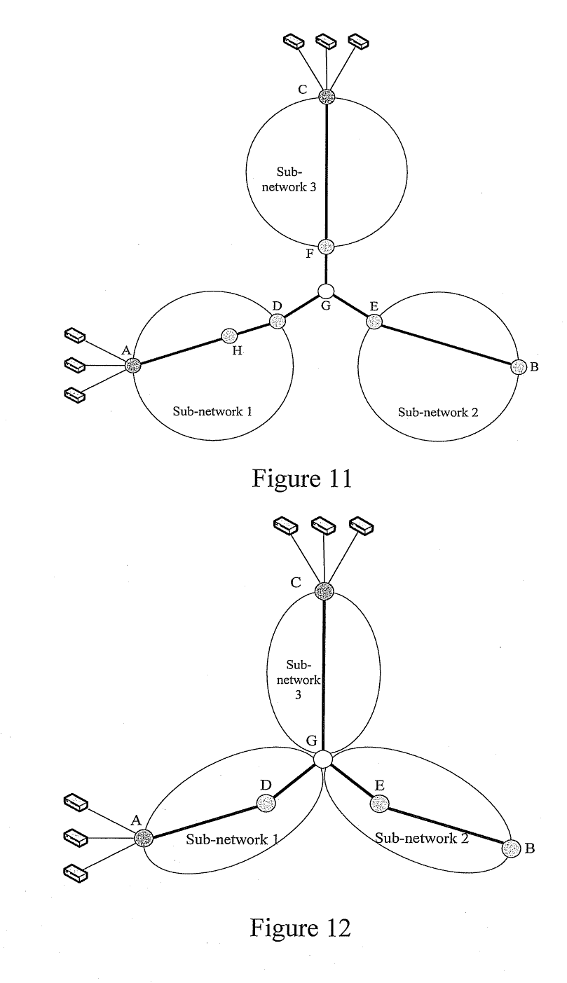

The third enhanced topology of three virtual MAC sub-networks is shown in FIGS. 11 or 12. In FIG. 11, the virtual MAC gateway node G is separated and connected with three virtual MAC sub-networks via an edge node in each of the three virtual MAC sub-network. In FIG. 12, the virtual MAC gateway node G is located in the three virtual MAC sub-networks simultaneously. Nodes A and C are non-convergence nodes. Nodes B, D, E, F and H are convergence nodes. Forwarding entries to the virtual MAC address domains of three virtual MAC sub-networks are configured on Gateway node G. In FIG. 11, Gateway node G may not be configured with the virtual MAC address domain of the virtual MAC sub-network connecting therewith but only configured the forwarding table entries to three virtual MAC sub-networks. In FIG. 12, Gateway node G can be configured both the virtual MAC address domain of the virtual MAC sub-network connecting therewith and the forwarding table entries to three virtual MAC sub-networks.

As can be seen from the above virtual MAC sub-network topology, there are the following schemes for configuring the virtual MAC address on the virtual MAC gateway node.

a1. Configure the virtual MAC address of one virtual MAC sub-network connecting with the virtual MAC gateway node.

a2. Configure the virtual MAC address of two virtual MAC sub-networks connecting with the virtual MAC gateway node.

a3. Configure the virtual MAC address of more than two virtual MAC sub-networks connecting with the virtual MAC gateway node.

a4. Configure no virtual MAC address.

There are the following conditions for configuring the forwarding table entry.

b1. Configure the forwarding table entry in two virtual MAC sub-networks.

b2. Configure the forwarding table entry in more than two virtual MAC sub-networks.

There are the following conditions for the forwarding table entry of one virtual MAC sub-network.

c1. There is one node connecting to the virtual MAC gateway in the virtual MAC sub-network.

c2. There are more than one nodes connecting to the virtual MAC gateway in the virtual MAC sub-network.

In application, a practical virtual MAC gateway node configuration belongs to one of the above 42×2=16 schemes.

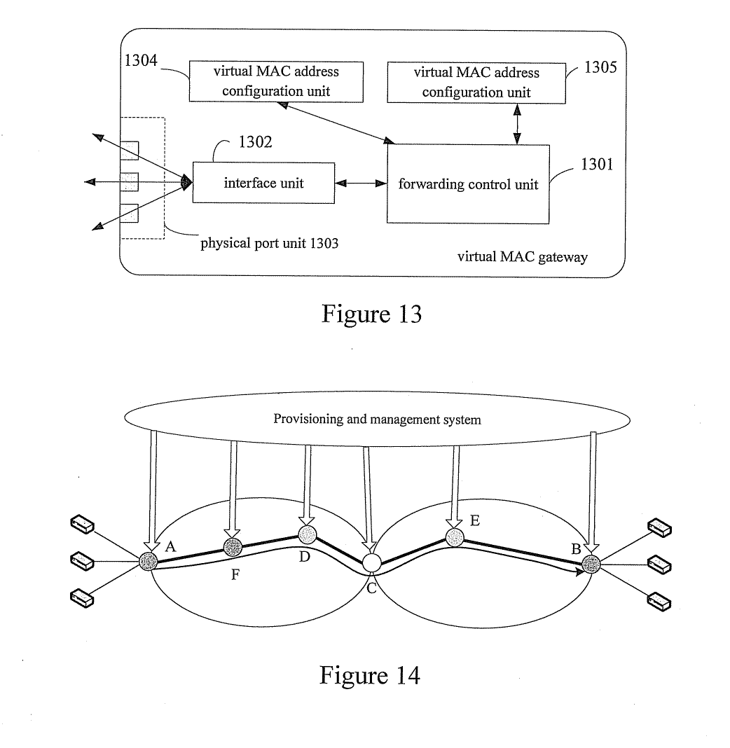

For the implementation of the above schemes, referring to FIG. 13, the structure of the virtual MAC gateway node includes forwarding control unit 1301, interface unit 1302, physical port unit 1303, virtual MAC address configuration unit 1304 and forwarding table configuration unit 1305.

Forwarding control unit 1301 receives a packet from interface unit 1302, looks up a virtual MAC address forwarding table from forwarding table configuration unit 1305 to obtain the corresponding physical port according to the destination virtual MAC address of a packet, and sending the packet to interface unit 1302.

Interface unit 1302 receives the packet from a node of the virtual MAC sub-network over physical port 1303, and sends the packet to forwarding control unit 1301. Alternatively, interface unit 1302 receives a packet from forwarding control unit 1301, and sends the packet to the corresponding physical port corresponding to physical port unit 1303.

Physical port unit 1303 consists of more than one physical port, each of which connects with a node of virtual MAC sub-network respectively for receiving and sending packets; such nodes may belong to the same or different virtual MAC sub-networks.

Virtual MAC address configuration unit 1304 configures the virtual MAC address of the virtual MAC address gateway or the virtual MAC address of a virtual MAC sub-network where the virtual MAC address gateway is located, and sends the virtual MAC address to each adjacent node connecting with the virtual MAC gateway via the interface unit for generating the virtual MAC address forwarding table of each adjacent node.

Forwarding table configuration unit 1305 receives the virtual MAC address from each adjacent node, generates a virtual MAC address forwarding table according to the received virtual MAC address, and saves the generated virtual MAC address forwarding table to be called by forwarding control unit 1301. A virtual MAC address forwarding table may also be configured by the provisioning and management system dynamically or statically. Therefore, forwarding table configuration unit 1305 may only save the virtual MAC address forwarding table.

An example is given for a more apparent structure of the system for implementing the address planning, configuration and forwarding function of the above virtual MAC sub-network and gateway more apparent. In the example, the system includes two virtual MAC sub-networks. With reference to FIG. 14, the system includes a provisioning and management system, virtual MAC sub-network 1 and virtual MAC sub-network 2. Each virtual MAC sub-network includes at least one node which may be a non-convergence node or a convergence node. There may be multi-level convergence in a virtual MAC sub-network according to practical requirements.

The convergence node receives a packet sent by a non-convergence node, a lower level convergence node or a virtual MAC gateway of the MAC sub-network in which the convergence node is located, looks up the virtual MAC address forwarding table configured on the convergence node according to the virtual MAC address of the packet, and sends the packet to the node corresponding to the virtual MAC address forwarding table. The node may be a non-convergence node, a convergence node or a virtual MAC gateway of the virtual MAC sub-network in which the convergence node is located. If there is no corresponding node in the virtual MAC address forwarding table, the packet will be discarded.

The provisioning and management system configures the ESP dynamically, and configures a virtual MAC address forwarding table on the nodes of the virtual MAC sub-network or the virtual MAC gateway node of the ESP statically or dynamically. The dynamic ESP configuration belongs to the content in the prior art.

The virtual MAC gateway forwards a packet between different virtual MAC sub-networks according to the virtual MAC address forwarding table and the destination virtual MAC address of a packet.

In applications, virtual MAC sub-networks and virtual MAC gateway may be any one of the above topologies or may be further extended based on the foregoing topologies. The method and principle for implementing the present invention is similar for different topologies.

The following advantages may be provided in the application of the solutions of the present invention.

Packets can be forwarded between different management domains through an ESP crossing the different management domain.

Different virtual MAC address domains of a same management domain may be interconnected through one ESP.

Forwarding table is simplified greatly by convergence of the forwarding table in upper-layer on some key nodes.

The management domain may be divided precisely as required, which improves the management efficiency and saves the virtual MAC address resource.

The above are only preferred embodiments of the present invention and are not for use in limiting the protection scope of the present invention. All the modifications, equivalent replacements or improvements within the spirit and principle of the present shall be included in the protection scope of the present invention.

What is claimed is:

1. A method for transmitting a packet, comprising:
receiving, by a first virtual MAC gateway, a packet from a first virtual MAC sub-network, and
sending, by the first virtual MAC gateway, the packet to a second virtual MAC sub-network according to a destination address of the packet and a virtual MAC address forwarding table;
wherein the first virtual MAC sub-network and the second virtual MAC sub-network corresponds to different virtual MAC address domains.

2. The method of claim 1, wherein the different virtual MAC address domains belong to different management domains.

3. The method of claim 1, wherein the destination address of the packet comprises a destination virtual MAC address or a destination virtual MAC address and virtual LAN Identifier (VID).

4. The method of claim 1, wherein the virtual MAC address forwarding table is received from a provisioning and management system.

5. The method of claim 1, wherein the virtual MAC address forwarding table is configured dynamically by the virtual MAC gateway according to virtual MAC addresses of adjacent nodes received from the adjacent nodes.

6. The method of claim 1, wherein the first virtual MAC gateway is located in the first virtual MAC sub-network, and the sending by the first virtual MAC gateway the packet to a second virtual MAC sub-network according to a destination address of the packet and a virtual MAC address forwarding table comprise:
sending, by the first virtual MAC gateway, the packet to a second virtual MAC gateway located in the second virtual MAC sub-network according to the destination address of the packet and the virtual MAC address forwarding table saved in the first virtual MAC gateway; and
sending, by the second virtual MAC gateway, the packet to at least one node in the second virtual MAC sub-network according to the destination address and a virtual MAC address forwarding table saved in the second virtual MAC gateway.

7. The method of claim 6, wherein the at least one node in the second virtual MAC sub-network is a convergence node or a non-convergence node.

8. The method of claim 6, wherein the sending by the first virtual MAC gateway the packet to the second virtual MAC gateway comprises:
sending, by the first virtual MAC gateway, the packet to the second virtual MAC gateway via at least one intermediate virtual MAC gateway.

9. The method of claim 1, wherein the virtual MAC address forwarding table comprises a relationship of virtual MAC address of the second virtual MAC sub-network and a node in the second virtual MAC sub-network;
wherein the sending the packet to a second virtual MAC sub-network according to a destination address of the packet and a virtual MAC address forwarding table comprises:
determining the virtual MAC address of the second virtual MAC sub-network according to the destination address of the packet; and
sending the packet to the node corresponding to the virtual MAC address of the second virtual MAC sub-network according to the virtual MAC address forwarding table.

10. A device for transmitting a packet, comprising a forwarding control unit, an interface unit and a forwarding table configuration unit; wherein
the forwarding control unit is configured to receive, via the interface unit, a packet from a first virtual MAC sub-network, and send the packet, via the interface unit, to a second virtual MAC sub-network according to a destination address of the packet and a virtual MAC address forwarding table in the forwarding table configuration unit;
the interface unit is configured to receive the packet from the first virtual MAC sub-network, and send the packet to the forwarding control unit; receive the packet from the forwarding control unit, and send the packet to the second virtual MAC sub-network; and
the forwarding table configuration unit is configured to save the virtual MAC address forwarding table;
wherein the first virtual MAC sub-network and the second virtual MAC sub-network corresponds to different virtual MAC address domains.

11. The device of claim 10, wherein the device is located in at least the second virtual MAC sub-network; the device further comprising:
a virtual MAC address configuration unit, configured to configure a virtual MAC address of the second virtual MAC sub-network.

12. The device of claim 11 wherein the virtual MAC address configuration unit is further configured to send the virtual MAC address of the second virtual MAC sub-network to a node adjacent to the device via the interface unit.

13. The device of claim 10, wherein the forwarding table configuration unit is further configured to configure the virtual MAC address forwarding table according to a virtual MAC address of an adjacent node received from the adjacent node.

14. The device of claim 10, wherein the device is located in a plurality of virtual MAC sub-networks including at least the first virtual MAC sub-network and the second virtual MAC sub-network simultaneously.

15. The device of claim 10, wherein the device is located in at least one virtual MAC sub-network selected from a plurality of virtual MAC sub-networks including at least the first virtual MAC sub-network and the second virtual MAC sub-network and connected with the other virtual MAC sub-network via a device located in the other virtual MAC sub-network.

16. The device of claim 10, wherein the device is separated from a plurality of virtual MAC sub-networks including at least the first virtual MAC sub-network and the second virtual MAC sub-network and connected with the plurality of virtual MAC sub-networks including at least the first virtual MAC sub-network and the second virtual MAC sub-network via an edge node in each of the plurality of virtual MAC sub-networks including at least the first virtual MAC sub-network and the second virtual MAC sub-network.

17. A system for transmitting a packet, comprising: a plurality of virtual MAC sub-networks and at least one virtual MAC gateway; wherein
the plurality of virtual MAC sub-networks corresponds to different virtual MAC address domains; each of the plurality of virtual MAC sub-networks comprises one or more nodes with virtual MAC addresses; each node forwards a packet to a next-hop node or the virtual MAC gateway according to a destination address of the packet and a virtual MAC address forwarding table; and
the virtual MAC gateway is configured to forward the packet among the plurality of the virtual MAC sub-networks according to the destination address of the packet and the forwarding table.

18. The system of claim 17, wherein the different virtual MAC addresses domains belong to different management domains.
